(19) United States
(12) Patent Application Publication
(10) Pub. No.: US 2009/0319299 A1
(43) Pub. Date: Dec. 24, 2009

(54) SYSTEM AND TECHNIQUES FOR REPORTING ADVERSE EFFECTS

(75) Inventors: Glen Michael De Vries, New York, NY (US); Barton Lewis Cobert, Westfield, NJ (US); Jordan Bergtraum, New York, NY (US)

Correspondence Address: HOFFMANN & BARON, LLP, 6900 JERICHO TURNPIKE, SYOSSET, NY, 11791, US

(73) Assignee: MEDIDATA SOLUTIONS, INC., New York, NY (US)

(21) Appl. No.: 12/143,386

(22) Filed: Jun. 20, 2008

(51) Int. Cl. G06Q 50/00

(52) U.S. Cl. 705/3

(57) ABSTRACT

Techniques for collecting and reporting adverse events associated with a patient are disclosed. The techniques include providing a user interface to identify drug and medical conditions associated with the patient using standardized drug and medical terminology. The techniques also include generating and displaying a cumulative narrative of user selections on the interface. The cumulative narrative can be directly transmitted to one or more companies and/or and regulatory agencies.

### FIELD OF THE INVENTION

The disclosure generally relates to reporting systems, and more particularly to collecting and reporting adverse events.

### BACKGROUND OF THE INVENTION

Drug safety and pharmacovigilance are important issues throughout the world. The attention these issues generally receive, however, has been negative. In the United States, for instance, the U.S. Food and Drug Administration (FDA) has been criticized for allowing drugs perceived by many as unsafe to enter and remain on the market, taking delayed action, and requiring product withdrawal only after major health problems have occurred. For example, there have been over twenty (20) product withdrawals from the U.S. market since 1980.

Generally, the drug safety systems for marketed drugs in the U.S., E.U., Japan, Canada and most of the other major countries involve the voluntary reporting of adverse events (formerly called “side effects”) to the manufacturer or the national health agency. Typically, the manufacturer is required to report all serious adverse events (SAEs) and most non-serious ones to the appropriate health agencies in the countries where the drug is marketed. The techniques utilized by these systems typically rely on phone, e-mail and facsimile technology, resulting in a low percentage of all SAEs being reported. These systems also tend to require that all information be manually recorded, reviewed and be finally uploaded into one or more databases at the company and/or health agency for review by physicians responsible for food and drug safety.

As a result, companies and health agencies spend a considerable amount of time and resources to receive and analyze a sufficient number of cases with sufficient data and links between the drug or food and toxicity to make changes in the use of the drug or food (e.g. limit use to only certain patients or consumers, add warnings to the labeling, limit use to only certain diseases, limit doses in certain patients etc.) or to withdraw the product from the market. For example, the withdrawal of Baycol®, Vioxx® and Zelnorm® products required between four (4) and five (5) years of data gathering and analysis. In addition, the manual techniques used by these systems frequently result in backlogs in data entry by health agencies and companies.

Consumers and health care professionals (HCPs) are also discouraged from reporting SAEs because there is no easy and rapid way of doing so. For example, in the U.S., most cases are reported by consumers and HCPs by telephone to pharmaceutical companies or manufacturers which usually requires that the caller first identify the company and find its phone number in order to call. The contacts usually lead to one or more lengthy discussions. As HCPs and consumers generally have tight schedules and are not reimbursed for such reporting, there exists reluctance among some consumers and HCPs in reporting adverse events.

Accordingly, there exists a need for an improved system and technique for reporting adverse events relating to consumer products.

### SUMMARY OF THE INVENTION

Techniques for collecting and reporting adverse events associated with a patient are disclosed. The techniques include providing a user interface to identify drug and medical conditions associated with the patient using standardized drug and medical terminology. The techniques also include generating and displaying a cumulative narrative of user selections on the interface. The cumulative narrative can be directly transmitted to one or more companies and/or and regulatory agencies.

For example, according to one aspect, a computer-based method of collecting and reporting adverse events associated with a patient includes providing a user interface capable of (i) prompting a user to identify information to be associated with a patient, the information including at least one of personal information, medical information, drug information, adverse event information, and (ii) associating the drug information and the medical information with the adverse event information in response to a request from the user.

The method also includes displaying iteratively a cumulative narrative on the user interface in response to the user identifying at least one of the personal information, medical information, drug information, adverse event information, and the association. Preferably for reporting to health authorities, the cumulative narrative describes the information in a standard format using a standardized nomenclature.

Preferably, the user of the system is a medical professional (e.g. a physician, nurse, pharmacist) or a patient. In one preferred embodiment, the method includes transmitting the cumulative narrative to a regulatory body. In another preferred embodiment, the method includes transmitting the cumulative narrative to a manufacturer or a data collection organization.

In one preferred embodiment, the method of prompting the user to identify information to be associated with the patient includes guiding the user using one or more display panels included in the user interface. Preferably, prompting the user to identify the information to be associated with the patient includes providing a user-selectable list on the user interface, the user-selectable list including entries conforming to the standardized nomenclature.

Prompting the user for the personal information can include providing a data entry area on the user interface for specifying a patient's initials, a patient-gender identifier, and a patient date-of-birth. The method can also include providing a user-selectable list including entries of a case outcome on the user interface. Preferably, the entries are selected from the group consisting of ‘congenital anomaly/birth defect’, ‘death’, ‘disabilities or permanent damage’, ‘hospitalization (initial or prolonged)’, ‘life-threatening’, ‘other serious/important medical event’ and combinations thereof (representing FDA approved categories and definitions).

In one preferred embodiment, prompting the user for the medical information includes providing a user-selectable list including entries of a current relevant medical condition on the user interface, the entries defined by the standardized nomenclature. Prompting the user for the medical information can include providing a user-selectable list including entries of a relevant surgery procedure name on the user interface, the entries defined by the standardized nomenclature. Prompting the user for the drug information can include providing a data selection area on the user interface for specifying a drug name, suspect identifier, start date and end date. Preferably, prompting the user for the adverse event information includes providing a data selection area on the user interface for identifying a drug name, a severity identifier, a start date and an end date.

In one preferred embodiment, describing the information using the standardized nomenclature includes selecting and displaying a drug term from a WHO Drug Dictionary. Describing the information using the standardized nomenclature can also include selecting and displaying a medical term from a Medical Dictionary for Regulatory Activities (MedDRA) database.

Preferably, describing the information in the standard format includes formatting the cumulative narrative and data into an E2B data format. The method can also include transmitting the E2B data format to at least one of a regulatory database and company safety database. In one embodiment, the method also includes providing an electronic acknowledgement to said user upon transmission of said E2B data format.

In yet another embodiment, the method includes storing the cumulative narrative in a database.

Preferably, providing the user interface includes transmitting the user interface over a network to a display device. In one embodiment, associating the drug information and the medical information with the adverse event information includes dragging one or more drug information and medical information onto the adverse event information displayed on the user interface.

A system, as well as articles that include a machine-readable medium storing machine-readable instructions for implementing the various techniques, are disclosed. Details of various embodiments are discussed in greater detail below.

In some embodiments, one or more of the following advantages may be present. For example, the disclosed techniques can facilitate the process by which consumers and HCPs report adverse events by prompting and guiding them through the reporting process.

An additional advantage may relate to increased accuracy of reporting adverse events. For example, by providing user-selectable lists of drug and medical terms that are pre-defined using a standardized nomenclature, data entry can be minimized and drug and medical conditions can be accurately described.

Another advantage may relate to timeliness of reporting adverse events. For example, by directly transmitting information to companies and heath agency databases, time spent manually entering adverse event information into these databases can be minimized. Direct upload into a health agency database without the need for manual entry decreases agency workload and data entry errors as well as making the data available immediately in real time.

Additional features and advantages will be readily apparent from the following detailed description, the accompanying drawings and the claims.

### BRIEF DESCRIPTION OF THE DRAWINGS

FIG. 1 is a block diagram of a system for collecting and reporting adverse events according to the present invention;

FIGS. 2A-2G illustrate an exemplary method of collecting and reporting adverse events according to the present invention;

FIGS. 3-26 illustrate an example graphical user interface for use with the system of FIG. 1.

Like reference symbols in the various drawings indicate like elements.

### DETAILED DESCRIPTION OF THE PREFERRED EMBODIMENTS

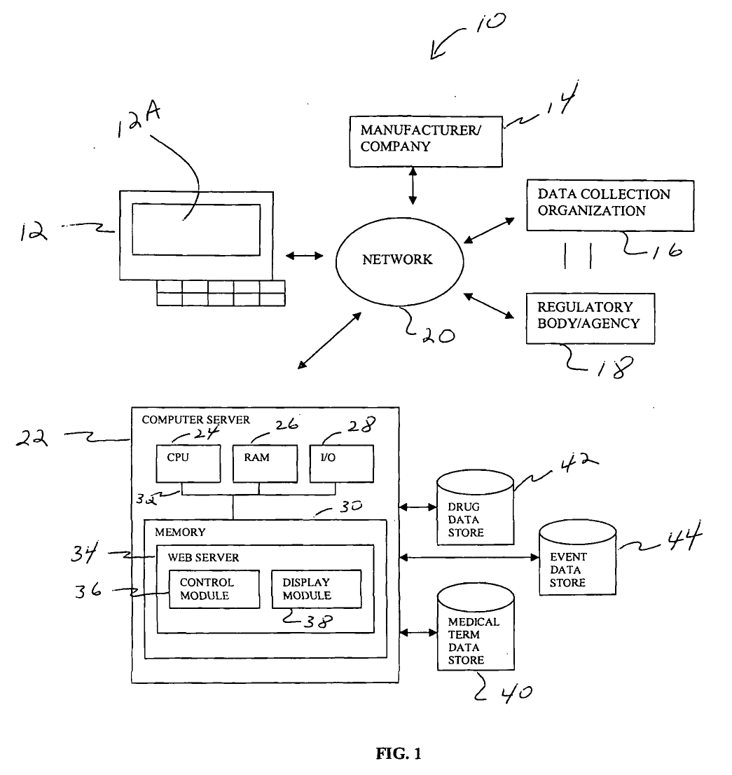

FIG. 1 shows a computer-based system 10 for collecting and reporting adverse events associated with a patient. Although the example discussed below relates to the medical field, it will be appreciated by one skilled in the art that the present system and techniques can be utilized across various types of industries. For example, the system and techniques disclosed herein can be utilized for collecting and reporting information relating to food, nutraceuticals, nutritionals, cosmetics, health foods, natural foods/products/medicines, biologics, radiologicals, over-the-counter products, as well food supplements.

Preferably, the system 10 is configured to include an access device 12 that is in communication with a server 22 over a network 20. The access device 12 can include a personal computer, laptop computer, or other type of electronic device, such as a cellular phone or Personal Digital Assistant (PDA). Preferably, the access device 12 is configured to include a browser 12A that is used to request and send information to the server 22. Although only one access device is shown in FIG. 1, the system can support multiple access devices.

The network 20 can include various devices such as routers, server, and switching elements connected in an Intranet, Extranet or Internet configuration. In some embodiments, the network 20 uses wired communications to transfer information to and from the access device 12 and the server 22. In another embodiment, the network 20 employs wireless communication protocols. In yet other embodiments, the network 20 employs a combination of wired and wireless technologies.

As shown in FIG. 1, one or more manufacturer's, such as drug and food manufacturers, can be connected to the network 20 and can receive processed information from the server 22 in response to information identified from the access device 12. Similarly, one or more regulatory bodies or agencies can be connected to the network 20 and be configured to receive processed information from the server 22 in response to information entered on the access device 12. In yet another embodiment, a data collection organization 16 is connected to the network 20 to receive information from the server 22 and to transmit the same to an appropriate manufacturer and/or regulatory agency. Of course, it will be appreciated by one skilled in the art that various configurations of manufacturers, regulatory agencies and data collection organizations can be configured in the system 10 without departing from the scope and spirit of the present disclosure or claims.

The computer server 22 preferably includes a central processing unit (‘CPU’) 24, random access memory (‘RAM’) 26, non-volatile memory 30 and an input-output device 28, all of which are preferably interconnected via a common bus 32 and controlled by the CPU 24. In one preferred embodiment, the non-volatile memory 30 is configured to include a web server 34.

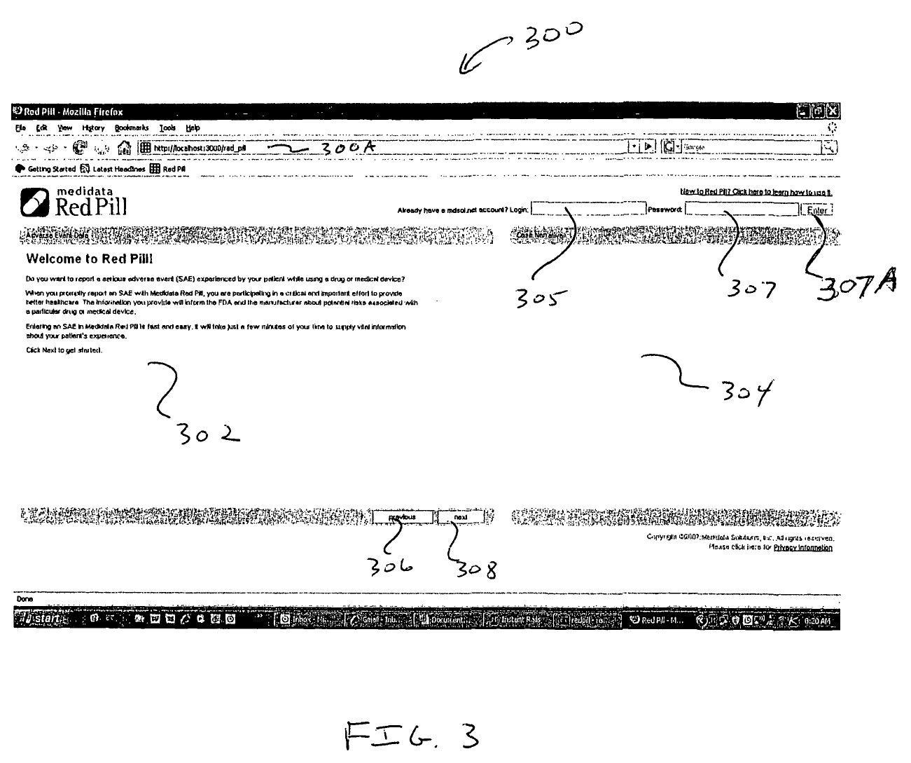

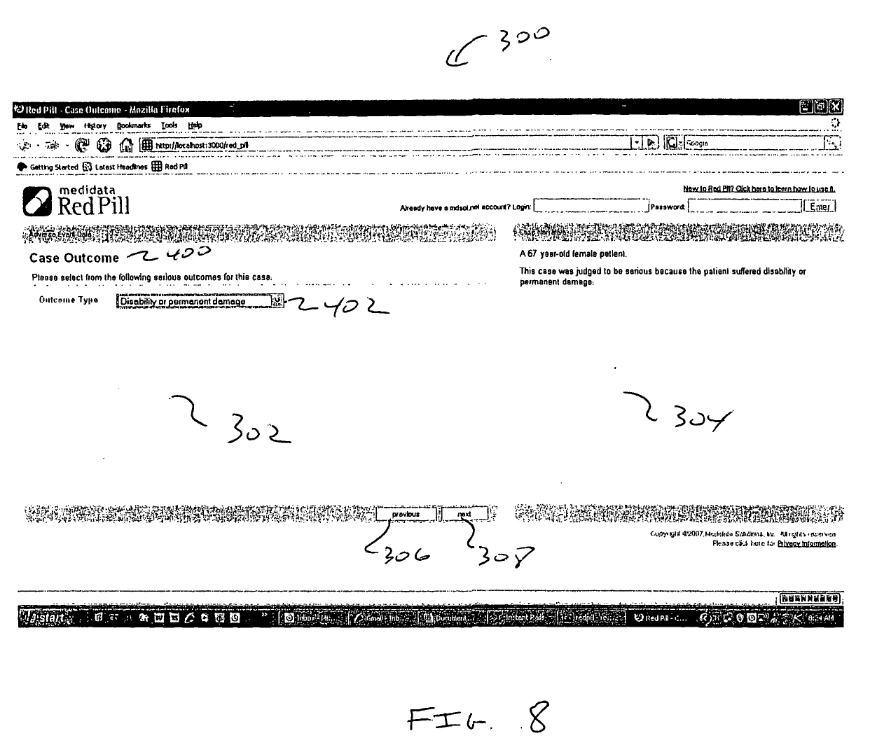

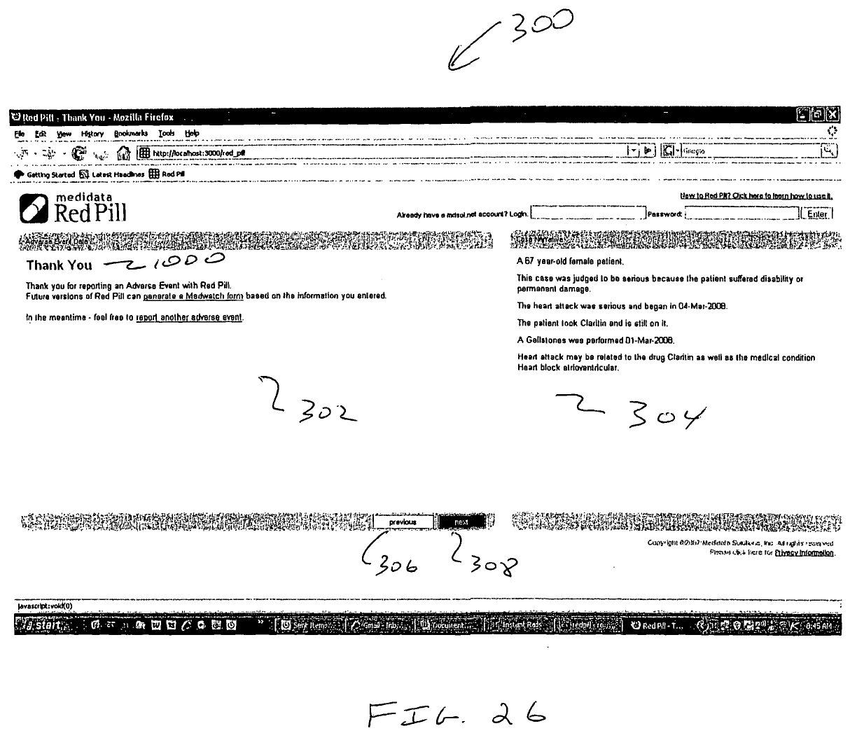

The web server 34 is provided and sends requested web pages to the browser 12A of the access device 12 in response to a web page request. The web server 30 communicates with the web browser 20 using one or more communication protocols, such as HTTP (Hyper Text Markup Language). In one embodiment, the web server 30 is configured to include the Java 2 Platform, Enterprise Edition (‘J2EE’) for providing a plurality of panels included in a user interface displayed on the browser. Details of the user interface are discussed in connections with FIGS. 3-26.

As shown in FIG. 1, the web server 34 provides a run-time environment that includes a control module 36 for prompting a user to identify information to be associated with a patient and for associating particular information with an adverse event. For example, in one preferred embodiment, the control module 36 prompts the user to identify personal information, drug information, and adverse event information, and associates drug information and medical information with the adverse event information in response to a request received from the browser 12A.

Preferably, the control module 36 iteratively generates a narrative representing information identified and/or selected by the user using one or more of the display panels included in the user interface. As the control module 36 guides the user in selecting and identifying information, user selections are appended to the narrative resulting in a cumulative narrative being generated and displayed iteratively based upon selections made by the user in the interface. The cumulative narrative that is generated uses a standardized nomenclature. An example of the iterative generation and display of the cumulative narrative is discussed in connection with the example shown in FIGS. 3-26.

The display module 38 of the web server 34 provides the user interface to the browser 12A in response to requests from tbe webs server 34 and control module 36. In one embodiment, the display module 38 uses eXtensible Markup Language (XML) to define and display the user interface on the browser 12A. In another preferred embodiment, the display module 38 is formed from one or more enterprise java beans (EJBs) that execute on the browser. An example of the user interface provided by the display module 38 is discussed in connection with FIGS. 3-26.

As shown in FIG. 1, drag and medical term data stores 20, 24 are provided that provide a standardized nomenclature for describing medical and drug information. For example, in one preferred embodiment, the drug data store 42 is an electronic WHO Drug Dictionary and the medical term data store 40 is an electronic Medical Dictionary for Regulatory Administration (MedDRA) database.

An event data store 44 is provided that is used to access and store information identified by users of the system. In one preferred embodiment, the event data store 44 is a relational database. In another embodiment, the event data store 44 is a directory server, such as a Lightweight Directory Access Protocol (‘LDAP’) server. In other embodiments, the event data store 44 is a configured area in the non-volatile memory 30 of the server 22.

Although the drug data store 42, medical term data store 40, and event data store 44 are not shown in FIG. 1 connected to the network 20, it will be appreciated by one skilled in the art that either the medical term, drug, or event data stores 40, 42, 44 can be distributed across various servers and be accessible to the server 22 over the network 20.

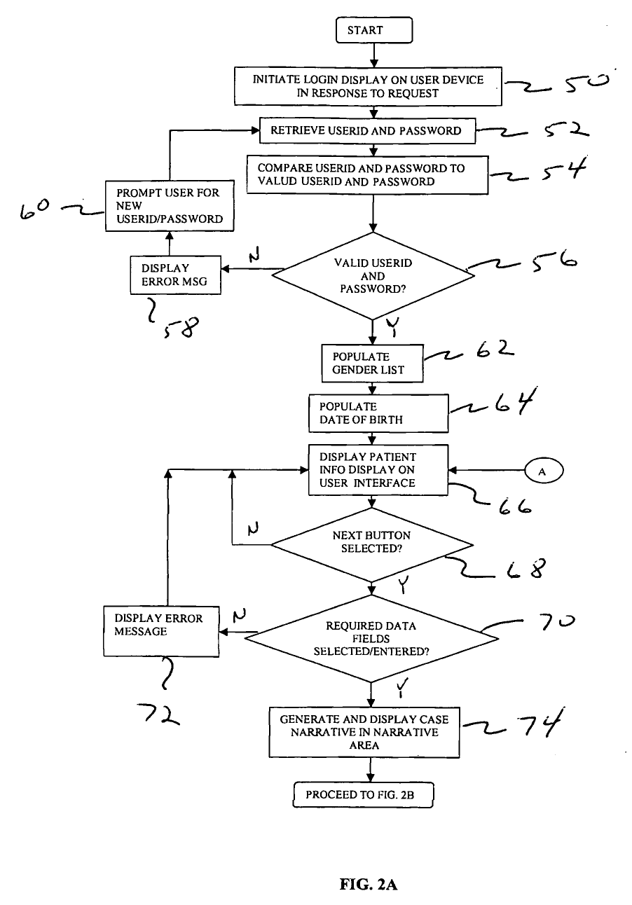

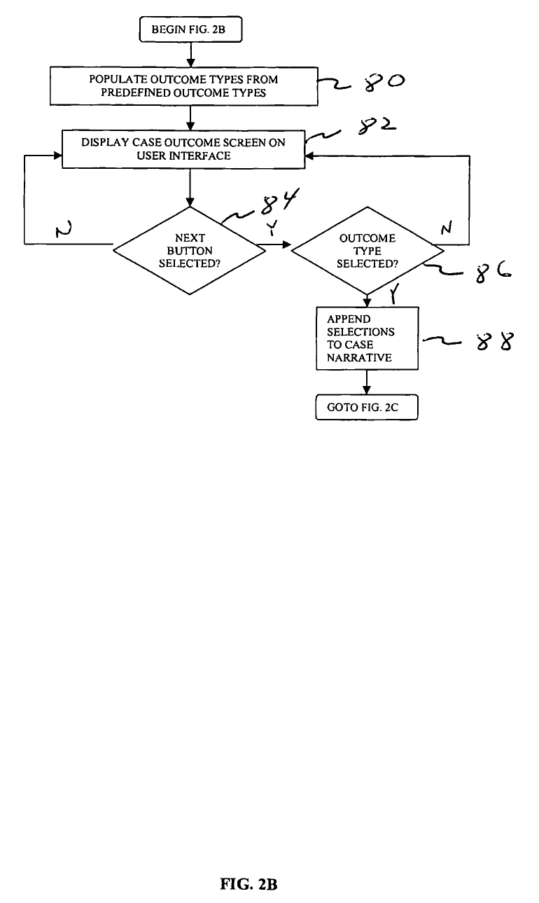

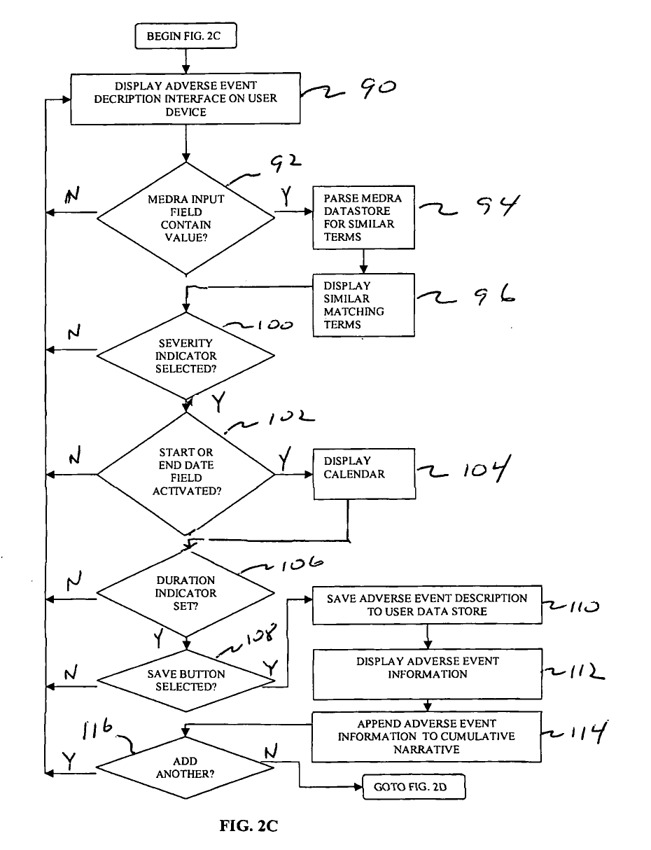

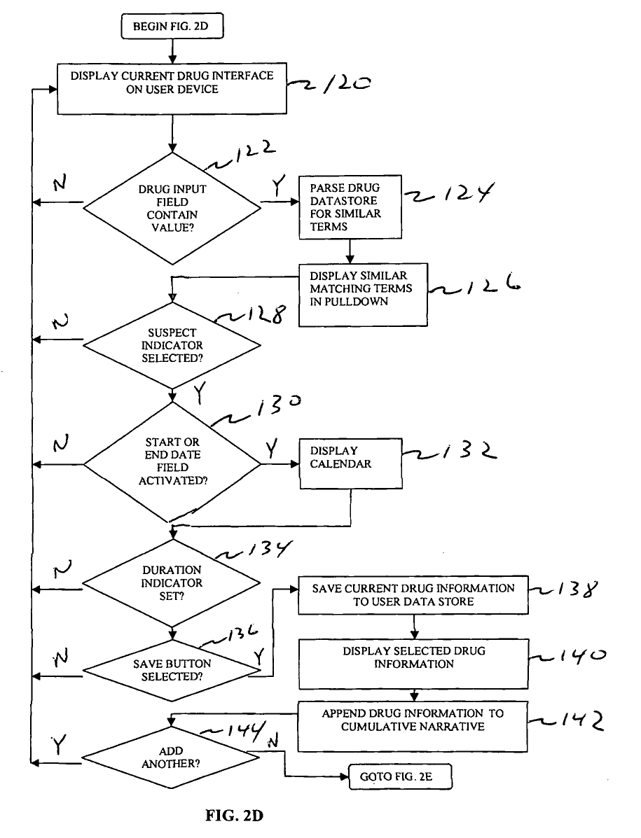

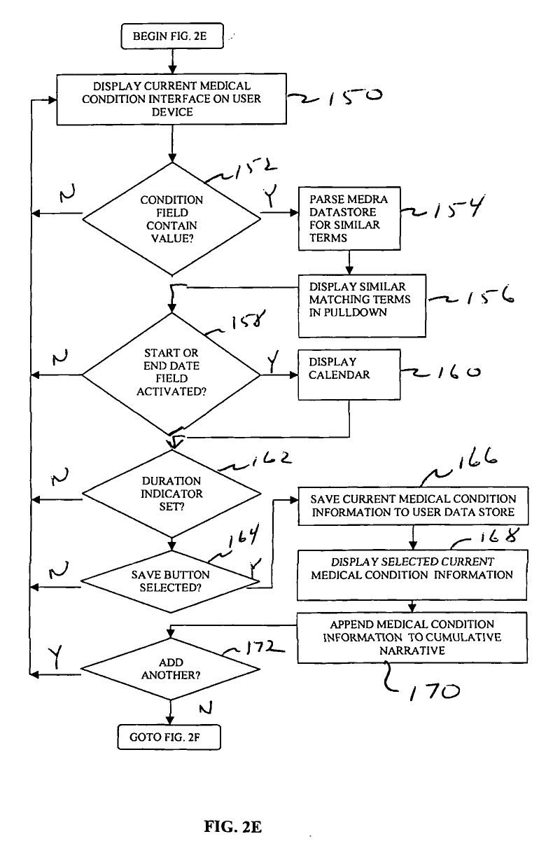

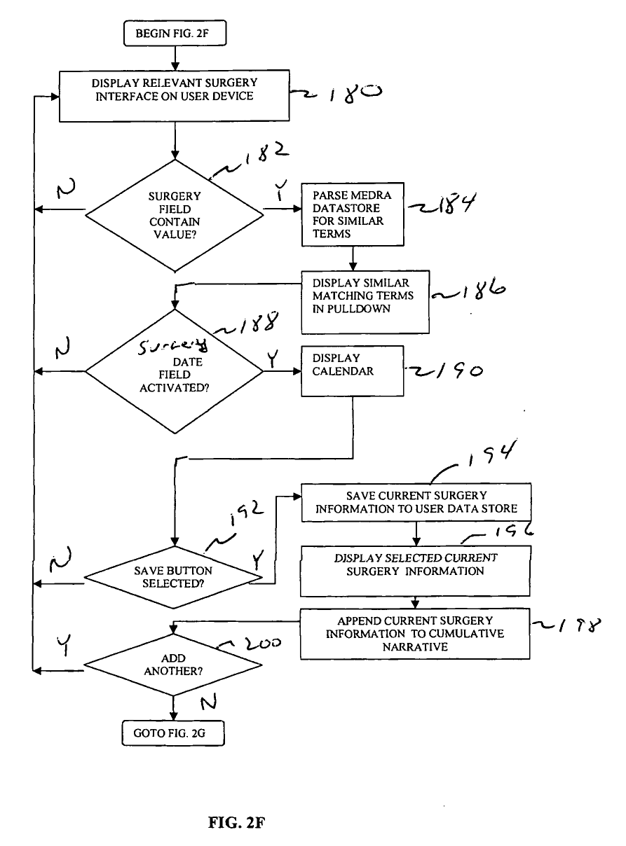

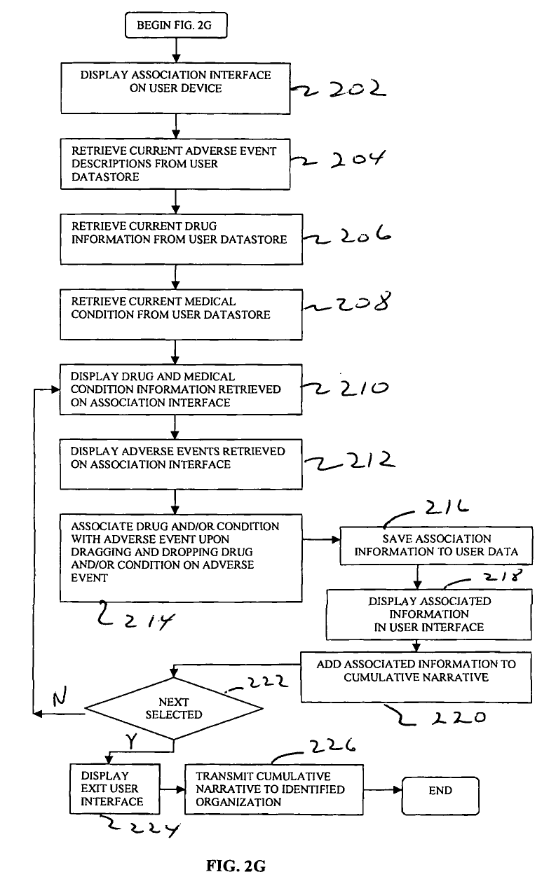

Turning now to FIGS. 2A-2G and 3, a flowchart of steps that are carried out by the system to collect and report adverse events and a user interface 300 provided by the system are disclosed. As shown in FIGS. 2A and 3, first, the control module 36 directs the display module 38 to display a login display 50 of the user interface 300 on the access device 12. As mentioned previously, preferably, the user interface 300 is displayed on the browser 12A of the access device 12. As shown in FIG. 3, the user interface 300 includes an adverse event area 302 that is used to prompt and guide the user to select and enter information to be associated with a patient, a case narrative area 304 that displays the particulars of an act or occurrence or course of events that the user identified in the adverse event area 302, and user selectable navigation buttons 306, 308 that allow the user to view previous and subsequent display panels of the interface 300.

Preferably, the user interface 300 also includes a login ID area 305 for entering a user ID and password area 307 for entering a user password. Upon selection of an enter button 307A, the display module 38 retrieves the user ID and user password entered 52 and transmits the same to the control module 36 for authorization. The control module 36 then compares the retrieved user ID and password entered to valid user IDs and passwords 54 that are stored in the event data store 44. If the control module 36 determines that a valid user ID and password was not entered 56, the control module 36 directs the display module 38 to display an error message 58 and to prompt the user for a new user ID and password 60. Otherwise, if a valid user ID and password were entered 56, the control module 36 directs the display module 38 to populate a user selectable gender list 62 and calendar entries for identifying a patient date of birth 64. Next, the control module 36 directs the display module 38 to display a patient information panel 310 in the adverse event area 302.

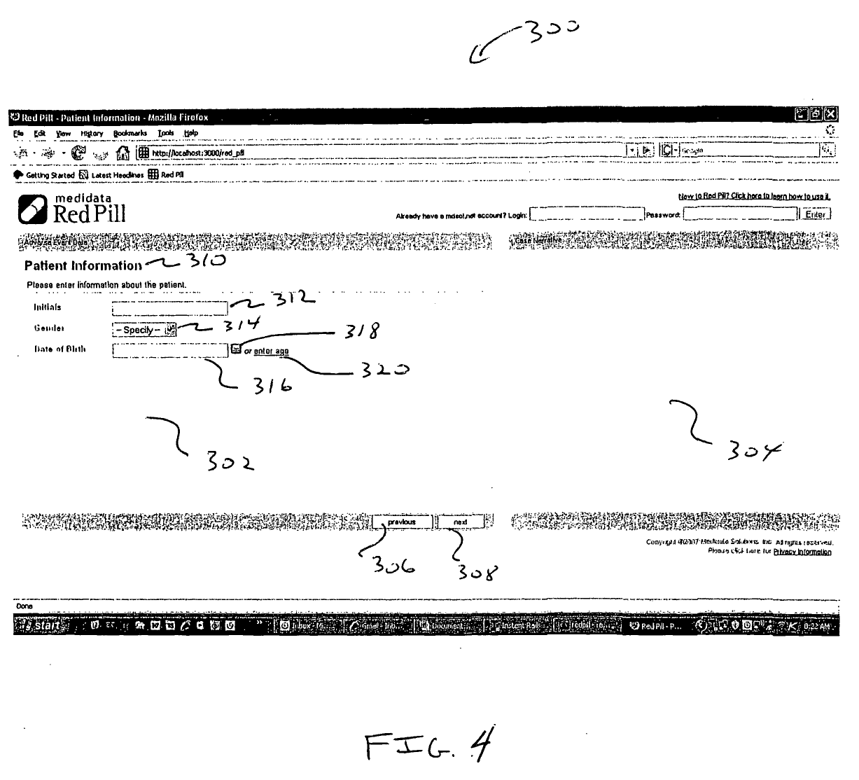

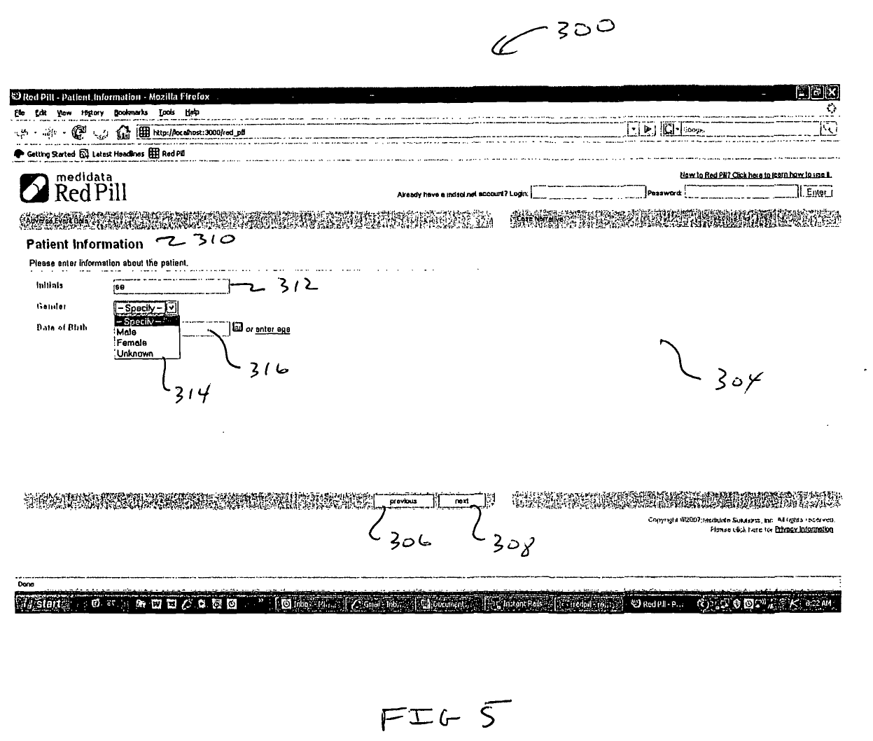

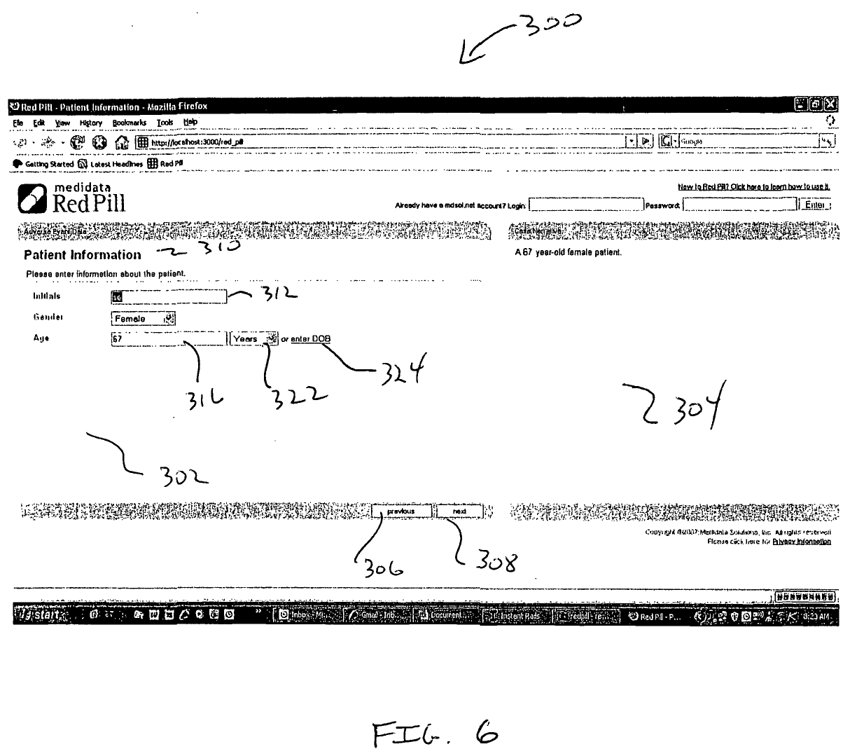

An example of the patient information display panel 310 and options are shown in FIGS. 4-6. In that example, the panel 310 includes an initials area 312 that a user can enter a patient's initials, a gender pull-down selection list 314 that contains pre-defined gender entries (FIG. 5), such as “MALE”, “FEMALE”, “UNKNOWN”, that were populated in step 62, a date-of-birth data entry area 316, a calendar selection box 318 that includes calendar entries that were populated in step 64, and an age identifier option 320 that allows the user to specify a particular age for the patient rather than specifying a birth date. For example, as shown in FIG. 6, upon the user selecting the age-identifier option 320, an age entry area 316 and a user-selectable age-identifier pull-down menu 322 containing entries such as “YEARS” and “MONTHS” can be associated with information entered into the age entry area 316. In the event the user desires to enter a specific data of birth, the patient display panel 310 also includes a DOB selection option 324 that displays the date-of-birth data entry area 316 and calendar selection box 318 shown previously in connection with FIG. 4.

Referring back to FIG. 2A, once the above described patient information has been selected and/or entered on the patient information display panel 310 and the user selects the next button 308, the display module 38 retrieves the selected and/or entered information and transmits the information 68 to the control module 36. The control module 36 then determines whether essential data fields, such as date-of birth or age, initials and gender have been entered and/or selected 70. If essential fields were not entered and/or selected, the control module 36 directs the display module 38 to display an error message 72 and the patient information display panel 310 is re-displayed in the adverse event area 302. If essential fields are entered, the control module 36 generates a narrative representing the information selected and/or entered and directs the display module 38 to display the same in the case narrative area 304. An example of the case narrative generated and displayed by the system in response to entering and/or selecting information from the patient information display panel 310 is shown in FIG. 6. Upon the user selecting the next button 308, the control module 36 directs the display module 38 to display a case outcome panel 400 in the adverse event area 302.

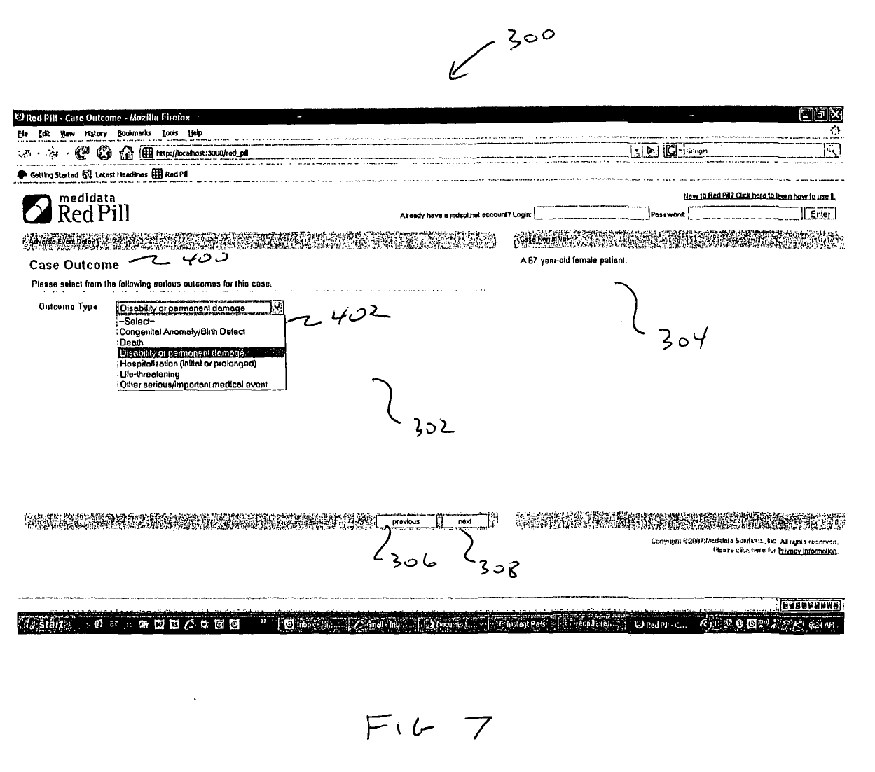

Referring now to FIGS. 2B, 7 and 8, an example of the case outcome panel 400 displayed in the adverse event area 302 and example method for providing the same are disclosed. As shown in FIG. 2B, the control module 36 first directs the display module 38 to populate a user selectable list of outcome types from a pre-defined list of outcome types 80 stored in the event data store 44 and then displays the case outcome panel 82 in the adverse event area 302. In one preferred embodiment, as shown in FIG. 7, example outcome types 402 can include “Congenital Anomaly/Birth Defect”, “Death”, “Disability or permanent damage”, “Life-threatening”, ‘hospitalization (initial or prolonged)’, ‘life-threatening’, ‘other serious/important medical event’ and combinations thereof. The display module 38 then determines whether the next button 308 has been selected 84.

If the next button 308 is selected, the control module 36 determines whether an outcome type has been selected 86. If an outcome type has been selected, the control module 36 compares the selected outcome type to a ranked scale of outcome types and generates a narrative representing the outcome type selected using a standardized nomenclature representing a severity level of the outcome. The control module 36 then directs the display module 38 to append the generated narrative onto the case narrative 88 resulting in a cumulative narrative representing information entered and/or selected in the patient information panel 310 and case outcome panels 400. The control module 36 then directs the display module 38 to display an adverse event description panel 500 in the adverse event area 302.

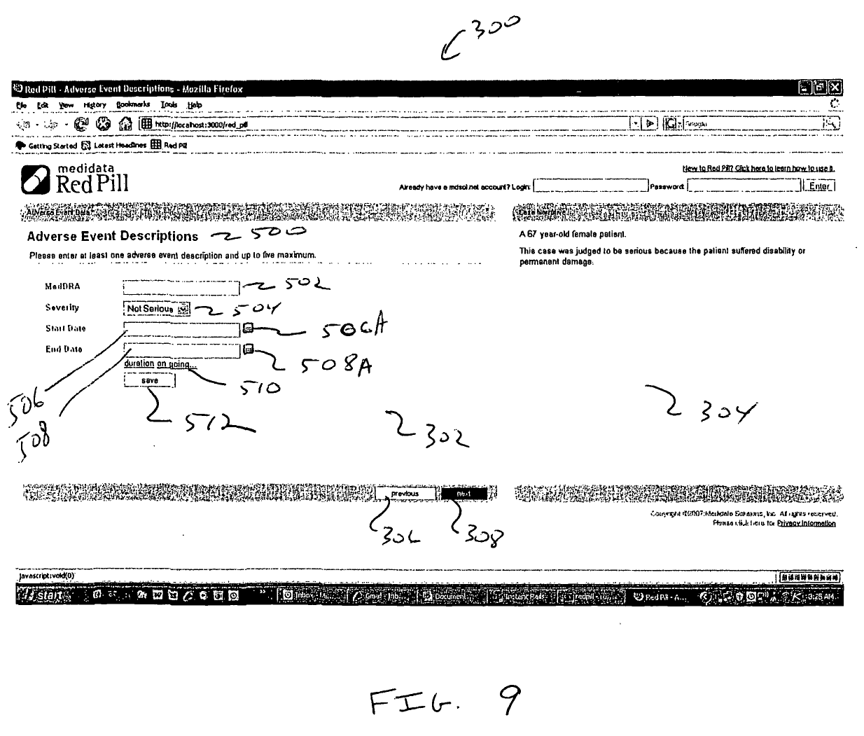

Turning now to FIGS. 2C and 9-13, an example of the adverse event description panel 500 and example method for providing the same are disclosed. The adverse event description panel 500 allows the user to specify medical events that are to be associated with the patient. As shown in FIG. 2C, in step 90, the control module 36 directs the display module 38 to display the adverse event description panel 500 in the adverse event area 302. As shown in FIGS. 9-12, the adverse event description panel 500 includes a medical event entry area 502, a pull-down severity menu 504 containing entries that are to be associated with an identified term in the medical term data entry area 502, a start date 506 and end date 508 data entry area that are used to identify the dates upon which an adverse event has occurred.

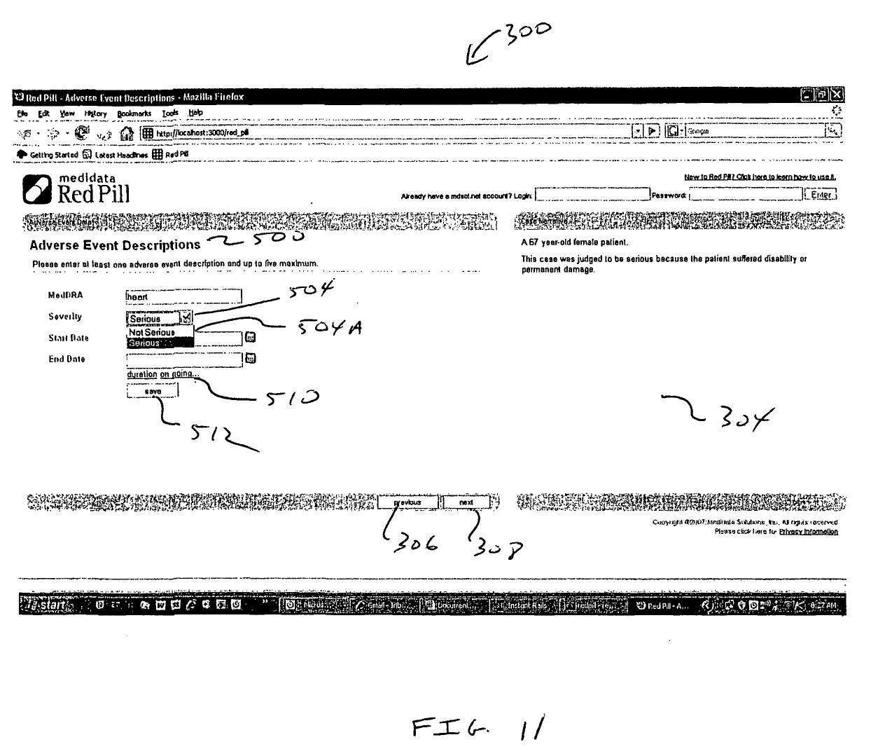

Preferably, each of the data entry areas 506, 508 are in communication with calendar selection boxes 506A, 508A that include calendar entries for selection by the user. In one preferred embodiment, as shown in FIGS. 9 and 11, a duration indicator 510 also is provided that allows the user of the system to specify whether the medical condition is on-going or is no longer continuing, and a save button 512 that once selected by the user results in information identified in the adverse event description panel 500 to be associated with the patient and saved in the event data store 44.

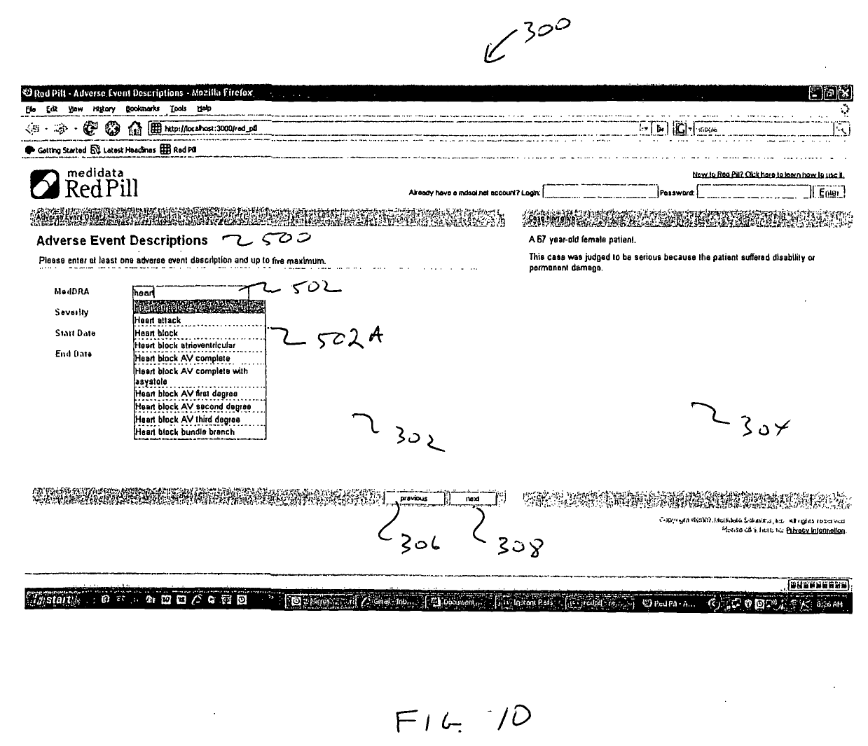

In one preferred embodiment, referring to FIG. 2C, upon the display module 38 displaying the adverse event description panel 500 on the user interface and populating values for the severity menu 504 for display 90, the display module 38 determines whether a value has been entered 92 into the medical event entry area 502. If a value has been entered, the display module 38 transmits the entered value to the control module 36 which then queries the medical data store 40 for terms that are similar to the value entered 94. Next, the control module 36 directs the display module 38 to populate a user selectable list 502A containing the query results and to display the same on the adverse event description panel 500 for selection by the user. For example, as shown in FIG. 10, entry of the term “heart” in the medical event entry area 502 results in user selectable entries such as “heart block” and “heart attack” being displayed in the user selectable list 502A.

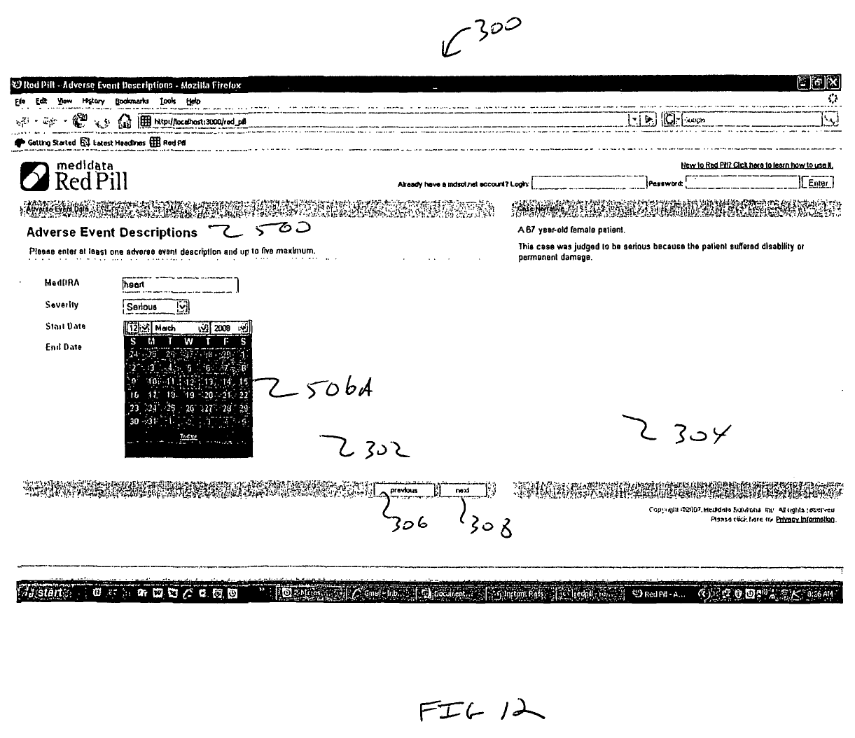

Upon the next button 308 being selected by the user, the control module 36 determines whether a selection is made 100 from the pull-down severity menu 504. As shown in FIG. 11, in one preferred embodiment, selection options 504A available from the pull-down menu 504 can include identifiers such as “Not Serious” and “Serious.” If the user made a selection 100 from the pull-down severity menu 504, the control module 36 determines whether the start date 506 and end date 508 were specified for the medical event. As shown in FIG. 12, in one preferred embodiment, calendar selection box 506A can be accessible to the user to specify a start date for the medical condition.

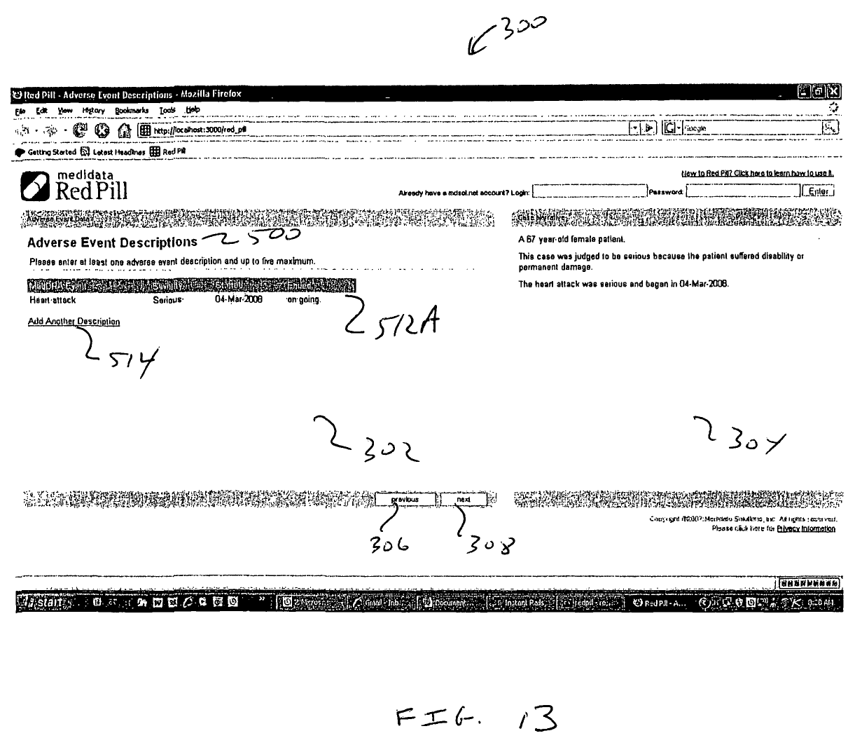

Next, the control module 36 determines whether the duration indicator 510 has been set by the user 106. Preferably, as shown in FIG. 11, the duration indicator 510 specifies whether the medical event occurred over a period of time or is on-going. As shown in FIG. 13 and step 108 of FIG. 2C, if the save button 512 is selected, the control module 36 saves any identified adverse event descriptions 110 to the event data store 44 and displays a record 512A of the stored information 112 in the adverse event description panel 500. In one preferred embodiment, multiple adverse event descriptions can be identified by the user in a similar fashion by selecting an add-another description link 514 provided in the adverse event area 302.

The control module 36 then generates a narrative representing the identified adverse event descriptions and directs the display module 38 to append the generated narrative onto the case narrative 114, resulting in a cumulative narrative 304 representing information entered and/or selected from the patient information panel 310, case outcome panel 400 and adverse event panel 500. If the user does not select the add another description link 514, the control module 36 directs the display module 38 to display a drug description panel 600 in the adverse event area 302.

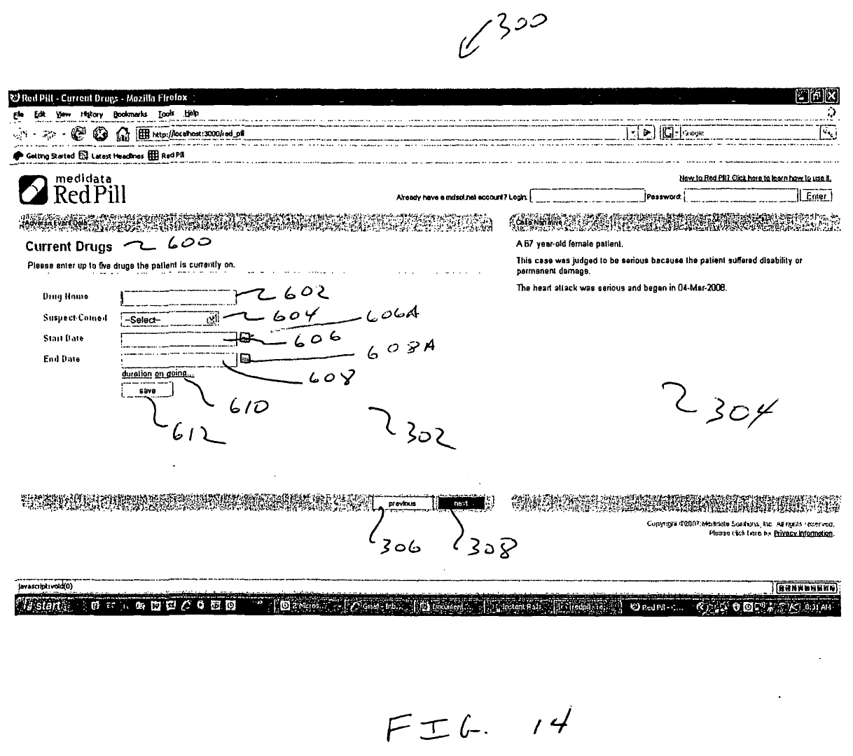

Referring now to FIGS. 2D and 14-17, an example of the drug description panel 600 and example method for providing the same are disclosed. The drug description panel 600 allows the user to specify any drugs that previously or currently are being administered to the patient. As shown in step 102 of FIG. 2D, the control module 36 first directs the display module 38 to display the drug description panel 600 in the adverse event area 302. As shown in FIGS. 14-16, the drug description panel 600 includes a drug entry area 602, a pull-down suspect/comed menu 604 containing entries that are to be associated with an identified drug in the drug entry area 602, a start date 606 and end date 608 data entry areas that are used to identify the dates upon which the patient received the drug. Similar to the start and end date data entry areas 506, 508 described in connection with FIGS. 9-13, preferably, each of the date data entry areas 606, 608 are in communication with calendar selection boxes 606A, 608A that include calendar entries for selection by the user.

As shown in FIG. 14, a duration indicator 610 also is provided that allows the user of the system 10 to specify whether the patient is currently being administered the drug identified in the drug entry area 602 or no longer is being administered the drug. A save button 612 is also provided that once selected by the user results in information identified in the drug description panel 600 to be associated with the patient and saved in the event data store 44.

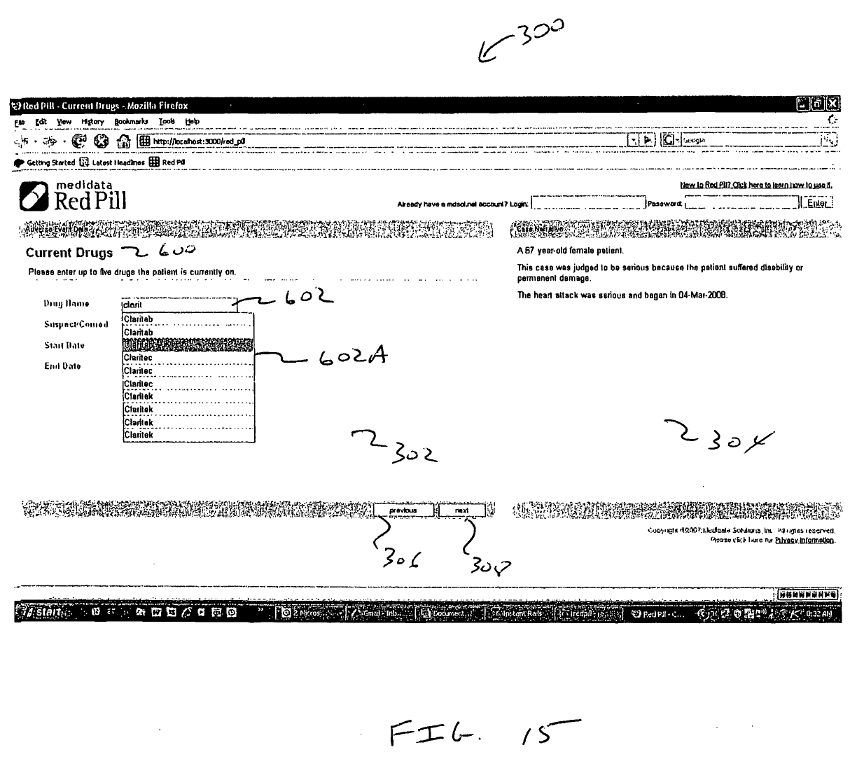

As shown in FIG. 2D and FIG. 15, upon the display module 38 displaying the drug description panel 600 on the user interface 300 and populating values for the suspect/comed menu 604 for display 120, the display module 38 determines whether a value has been entered 122 into the drug entry area 602. If a value has been entered, the display module 38 transmits the entered value to the control module 36 which then queries the drug data store 42 for terms that are similar to the value entered 124. Next, the control module 36 directs the display module 38 to populate a user selectable list 602A (FIG. 15) containing the query results and to display the same on the drug description panel 600 for selection by the user 126. For example, as shown in FIG. 15, entry of the term “clarit” in the drug entry area 602 results in user selectable entries such as “Claritab” and “Claritac” being displayed in the user selectable list 602A.

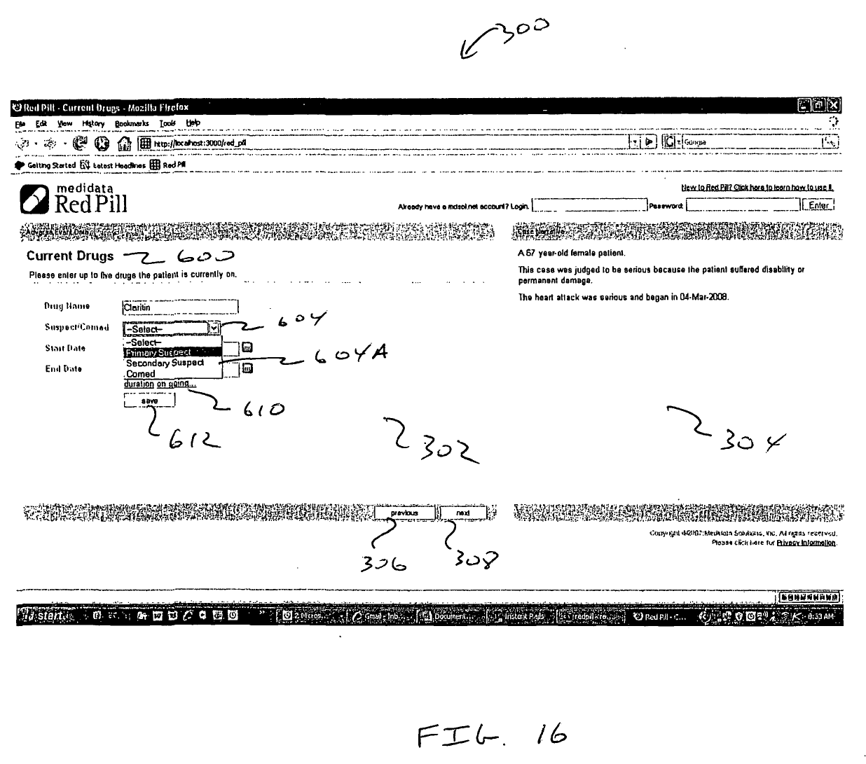

Referring back to FIG. 2D, upon the next button 308 being selected by the user, in step 128, the control module 36 determines whether a selection is made from the pull-down suspect/comed menu 604. As shown in FIG. 16, in one preferred embodiment, selection options 604A available in the pull-down menu can include identifiers such as “Primary Suspect” , “Secondary Suspect” and “Comed.” If the user made a selection from the pull-down severity menu, the control module 36 then determines whether the start date 606 and end date 608 were specified for the drug 130.

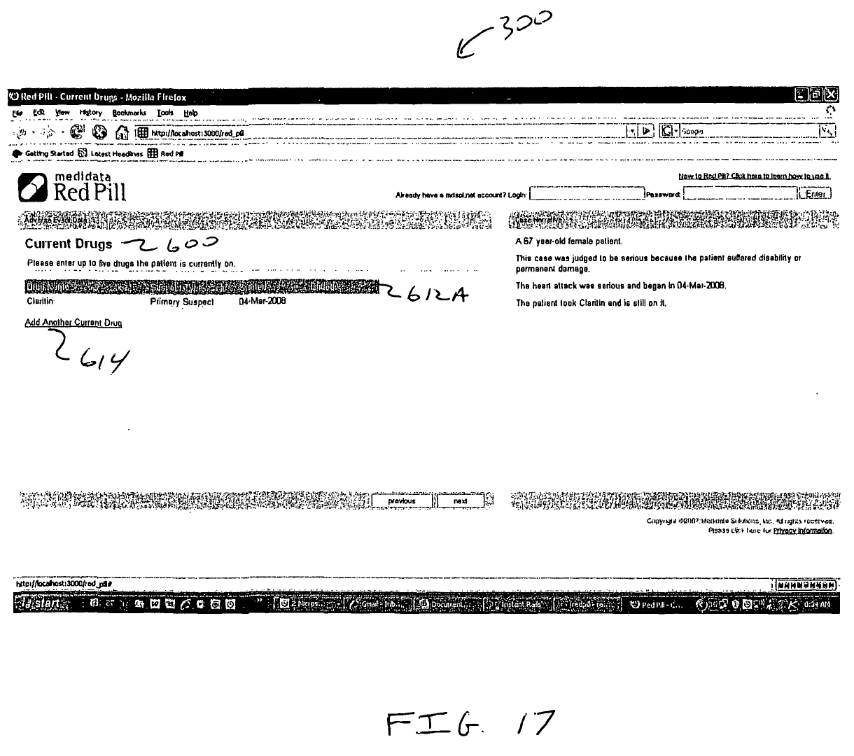

Next, the control module 36 determines whether the duration indicator 610 has been set by the user 134. Preferably, as shown in FIG. 16, the duration indicator 610 allows the user to specify whether the drug is still being administered or is no longer being administered. Next, as shown in FIG. 16 and 17, if the save button 612 is selected 136, the control module 36 saves any identified drug descriptions 138 to the event data store 44 and displays a record 612A of the stored information 140 in the drug description panel 600. Multiple drug descriptions can be identified by the user in a similar fashion by selecting the add-another drug link 614 provided in the adverse event area 302.

The control module 36 then generates a narrative representing the identified drug descriptions and directs the display module 38 to append the generated narrative onto the case narrative 142, resulting in a cumulative narrative 304 representing information entered and/or selected from the patient information panel 310, case outcome panel 400, adverse event panel 500 and drug description panel 600. If the user does not select the add-another drug link 614, the control module 36 then directs the display module 38 to display a medical condition panel 700 in the adverse event area 302.

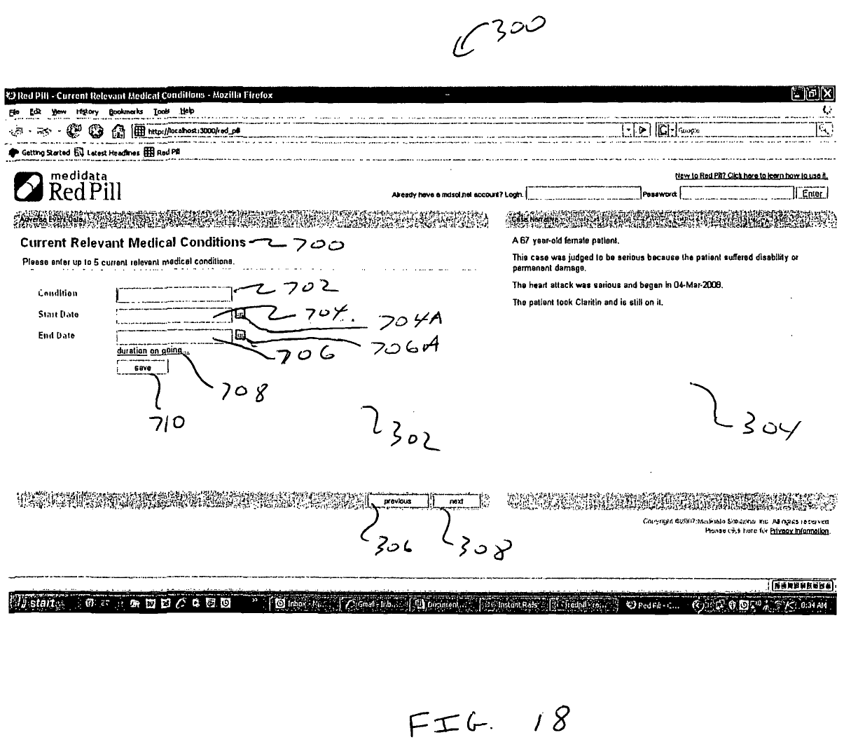

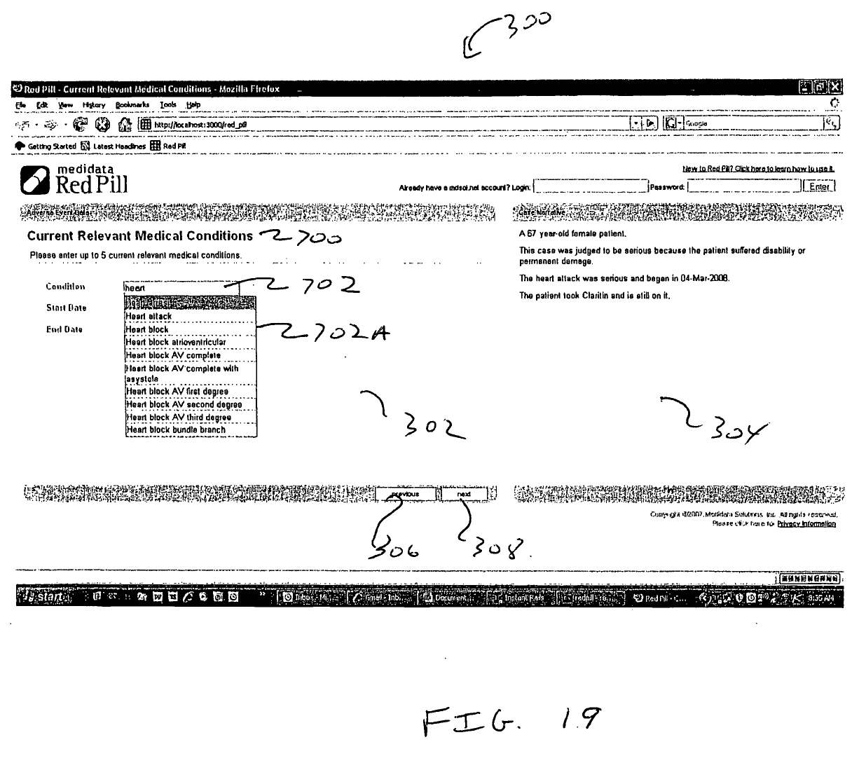

Turning now to FIGS. 2E and 18-20, an example of the medical condition panel 700 and example method for providing the same are disclosed. The medical condition panel 700 allows the user to specify any current relevant medical conditions associated with the patient. As shown in step 150 of FIG. 2E and FIG. 18, the control module 36 directs the display module 38 to display the medical condition panel 700 in the adverse event area 302. As shown in FIGS. 18-19, the medical condition panel 700 includes a condition entry area 702, a start date 704 and end date 706 data entry area that are used to identify the dates upon which the medical condition occurred, and a save button 710 that once selected, stores identified medical condition information to the event data store 44.

Similar to the start and end date data entry areas 506, 508 described in connection with FIGS. 9-13, preferably, each of the date data entry areas 704, 706 are in communication with calendar selection boxes 704A, 706A that include calendar entries for selection by the user. A duration indicator 708 also is provided that allows the user of the system to specify whether the medical condition identified for the patient currently exists or no longer exists for the patient.

In one preferred embodiment, as shown in step 152 of FIG. 2E, the display module 38 determines whether a value has been entered into the condition entry area 702. If a value has been entered, the display module 38 transmits the entered value to the control module 36 which then queries the medical data store 40 for terms that are similar to the value entered 154. Next, the control module 36 directs the display module 38 to populate a user selectable list 702A containing the query results and to display the same on the medical condition panel 700 for selection by the user 156. For example, as shown in FIG. 19, entry of the term “heart” in the condition entry area 702 results in user selectable entries such as “Heart attack” and “Heart block” being displayed in the user selectable list 702A.

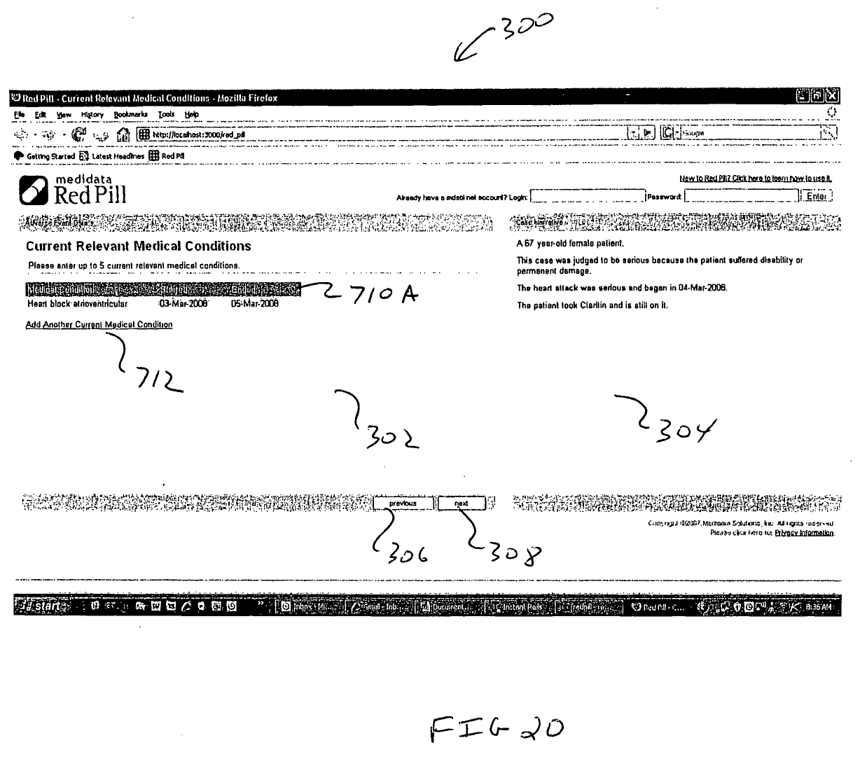

Referring back to FIG. 2E, upon the next button 308 being selected by the user, the control module 36 determines whether the start date 704 and end date 705 were specified for the medical condition 158. Next, the control module 36 determines whether a duration indicator 708 has been set by the user 162. Preferably, as shown in FIG. 18, the duration indicator 708 specifies whether the medical condition is existing or no longer exists for the patient. As shown in FIGS. 18 and 20, if the save button 710 is selected 164, the control module 36 saves any identified medical condition information 166 to the event data store 44 and displays a record 710A of the stored information 168 in the medical condition panel 700. Multiple medical conditions can be identified by the user in a similar fashion by selecting the add-another medical condition link 712 provided in the adverse event area 302.

As shown in FIG. 2E, at step 170, the control module 36 generates a narrative representing the identified medical conditions and directs the display module 38 to append the generated narrative onto the case narrative, resulting in a cumulative narrative 304 representing information entered and/or selected from the patient information panel 310, case outcome panel 400, adverse event panel 500, drug description panel 600 and medical condition panel 700. In the event additional medical conditions are not added by the user upon selection of the add-another medical condition link 712, the control module 36 directs the display module 38 to display a surgery panel 800 in the adverse event area 302.

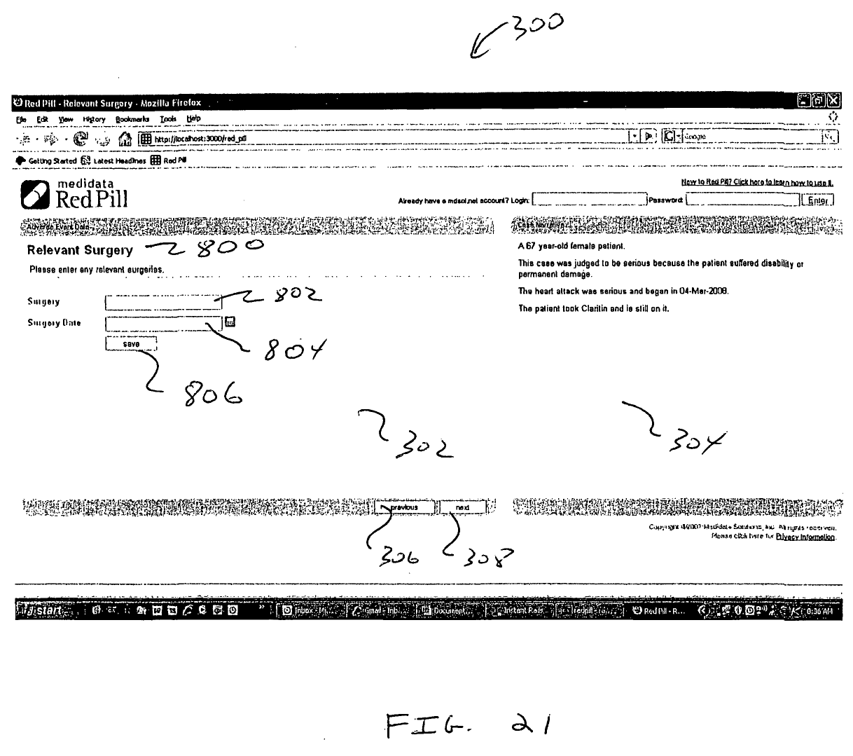

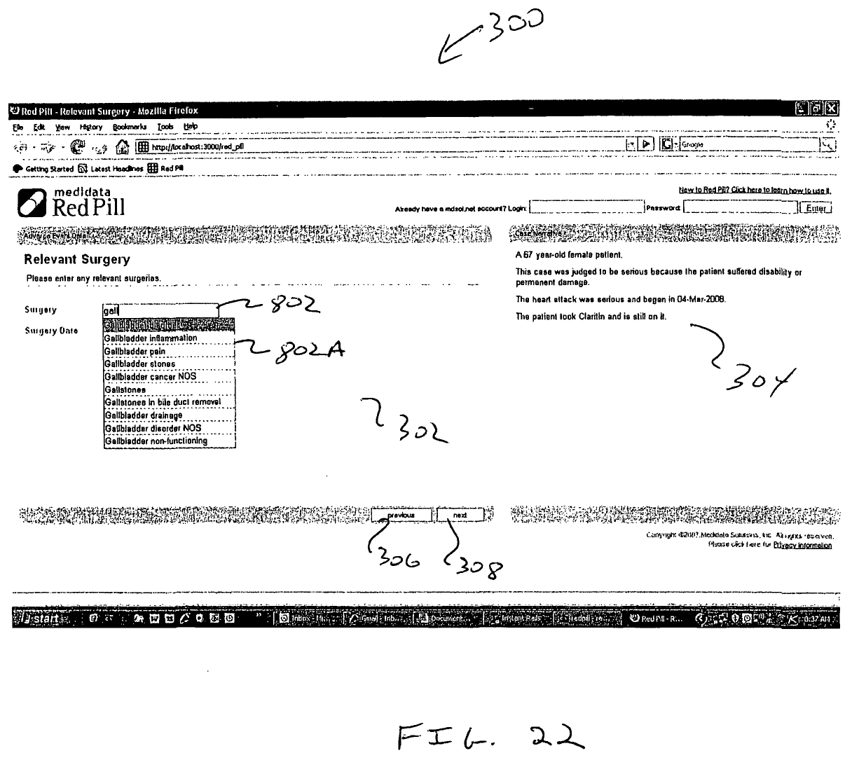

Referring now to FIGS. 2F and 21-23, an example of the surgery panel 800 and example method for providing the same are disclosed. The surgery panel 800 allows the user to specify any relevant surgeries that the patient may have undergone. As shown in FIGS. 2F and 21, the control module 36 directs the display module 38 to display 180 the surgery panel 800 in the adverse event area 302. As shown in FIGS. 21-22, the surgery panel 800 includes a surgery identification entry area 802, a surgery date area 804 used to identify the date upon which the surgery occurred, and a save button 806 that once selected, stores identified surgery information to the event data store 44.

In one preferred embodiment, as shown in FIG. 2F, upon the display module 38 displaying the surgery panel 800 on the user interface 300, the display module 38 determines whether a value has been entered 182 into the surgery identification entry area 802. If a value has been entered, the display module 38 transmits the entered value to the control module 36 which then queries the medical data store 40 for terms that are similar to the value entered 184. Next, the control module 36 directs the display module 38 to populate a user selectable list 802A containing the query results and to display the same on the surgery panel 800 for selection by the user 186. For example, as shown in FIG. 22, entry of the term “gall” in the entry area 802 results in user selectable entries such as “Gallbladder drainage” and “Gallstones ” being displayed in the user selectable list 802A.

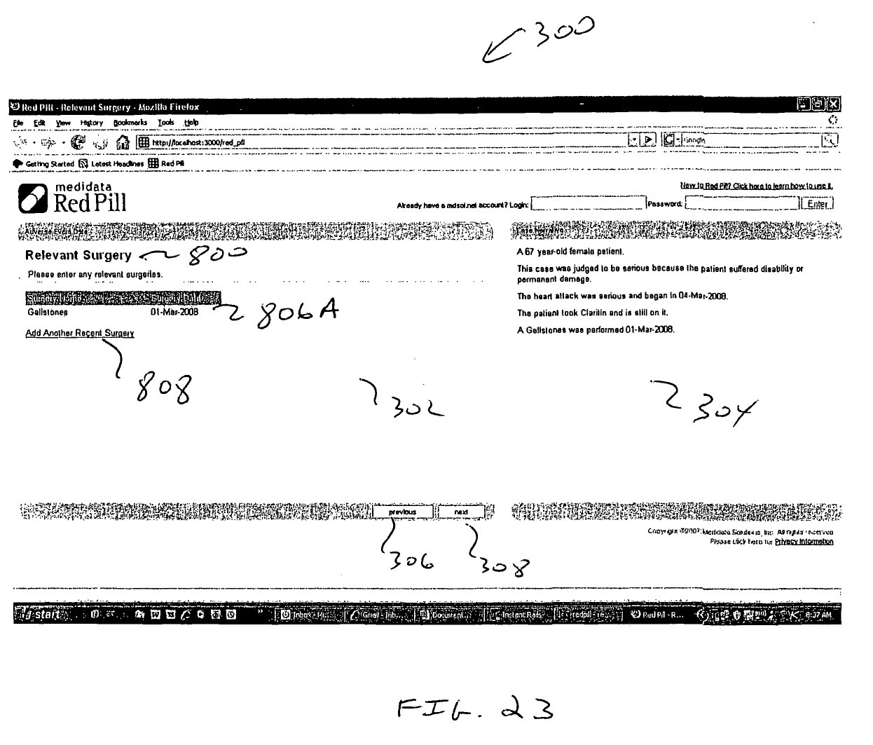

Turning back to FIG. 2F, upon the next button 308 being selected by the user, the control module 36 determines whether the surgery date area 804 is specified for the medical condition 188. If a valid value is entered in the surgery date area 804, the control module 38 then determines if the save button 806 is selected. As shown in FIGS. 21 and 23, if the save button 806 is selected 192, the control module 36 saves any identified surgical information 94 to the event data store 44 and displays a record 806A of the stored information 196 in the surgical panel 800. As shown in FIG. 23, multiple surgeries can be identified by the user in a similar fashion by selecting an add-another surgery link 808 provided in the adverse event area 302.

The control module 36 then generates a narrative representing the identified surgeries and directs the display module 38 to append the generated narrative 198 onto the case narrative, resulting in a cumulative narrative 304 representing information entered and/or selected from the patient information panel 310, case outcome panel 400, adverse event panel 500, drug description panel 600, medical condition panel 700, and surgery panel 800. If the user does not select the add-another surgery link 808, the control module 36 directs the display module 38 to display an association panel 900 in the adverse event area 302.

The association panel 900 allows the user to associate identified drugs and medical conditions with adverse events in an efficient and timely manner. For example, referring now to FIGS. 2G and 24-25, in one preferred embodiment, the control module 36 directs the display module 38 to display the association panel 900 on the user interface 300. Next, the control module 36 retrieves adverse event descriptions associated with the patient 204, any identified drug information associated with the patient 206, and any identified medical conditions for the patient 208 from the event data store 44.

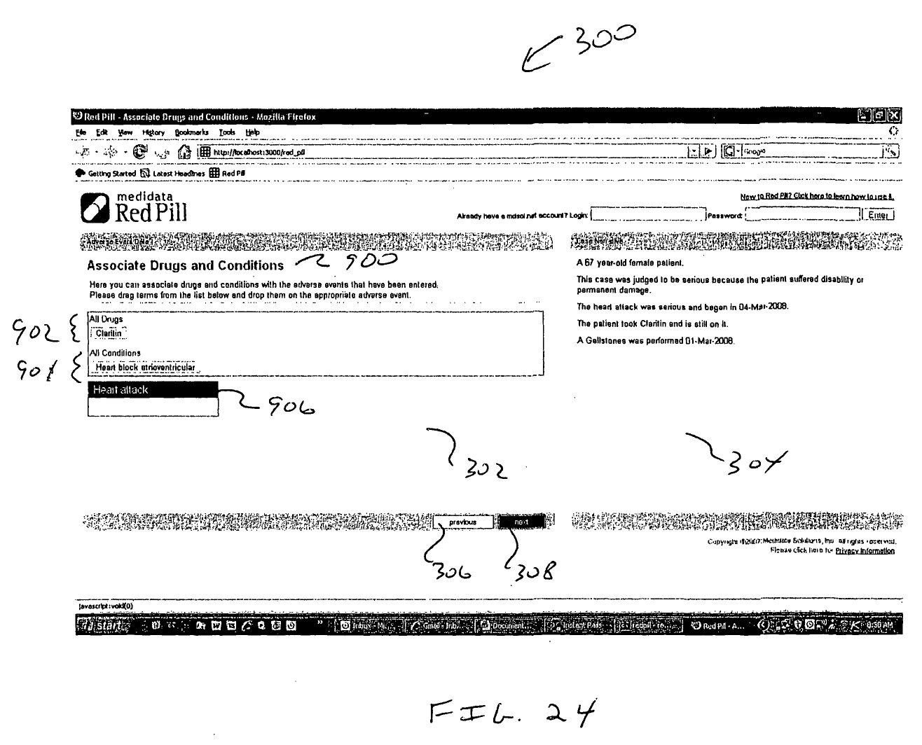

Next, the control module 36 directs the display module 38 to display the retrieved drug and medical condition information associated with the patient 210 in the association panel 900. Next the control module 36 directs the display module 38 to display any adverse events associated with the patient 212 on the association panel 900. For example, as shown in FIG. 24, selectable drug information 902, selectable condition information 904 and selectable adverse event information 906 associated with the patient are displayed by the display module 38 in the association panel 900.

Once the selectable drugs 902, medical conditions 904 and adverse event descriptions 906 are displayed on the association panel 900 by the display module 38, the control module 36 associates the retrieved drug information and medical information with the adverse event information in response to a request from the user 214. In one preferred embodiment, the user using an input/output device of the access device 12, such as a mouse, can drag and drop one or more drug information and/or medical information onto one or more adverse events to create an association.

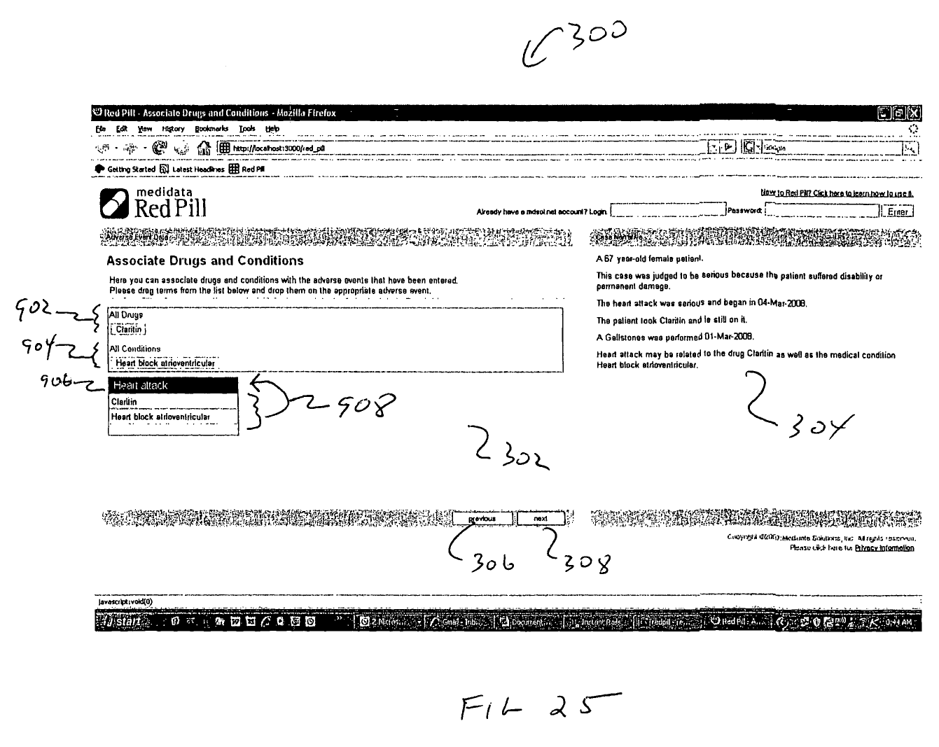

For example, as shown in the FIG. 25 example, the drug “Claritin” and medical condition “Heart block atriventricular” 908 can each be associated with the “Heart attack” adverse event 906. One or more drugs and medical conditions can be associated with one or more adverse event outcomes. Advantageously, this technique can greatly reduce the amount of time necessary to relate drug and medical condition information with an adverse event. Once an association is performed, the control module 36 stores the associations 216 to the event data store 44.

In one preferred embodiment, once an association is performed, the control module 36 generates a narrative representing the association and directs the display module 38 to append the generated narrative onto the case narrative 220, resulting in an cumulative narrative 304 representing information entered and/or selected from the patient information panel 310, case outcome panel 400, adverse event panel 500, drug description panel 600, medical condition panel 700, surgery panel 800 and association panel 900.

Preferably, as shown at step 222 in FIG. 2G, if the next button 308 is selected by the user, the control module 36 at step 224 directs the display module 38 to display an exit panel 1000 in the adverse event area 302, and transmits the cumulative narrative to a regulatory body, manufacturer or data collection organization for distribution to companies and regulatory bodies 226. Of course, it will be appreciated by one skilled in the art that multiple associations can be made between identified drugs, medical conditions and adverse event information using the presently described system and techniques.

Furthermore, in some preferred embodiment, upon selection of the next button 308, the control module 36 formats the cumulative narrative into a E2B data format and then transmits the E2B formatted data directly to a regulatory agency database and/or company safety database. Preferably, upon transmission, the control module 36 provides an electronic acknowledgement to the user upon transmission of the E2B data format.

Of course, it will be appreciated by one skilled in the art that the present invention is not limited to immediately transmitting the cumulative narrative or to the E2B data format. For example, the cumulative narrative can be transmitted in ASCII format using batch processing.

It will be appreciated that various of the above-disclosed and other features and functions, or alternative thereof, may be desirably combined into many other different systems or applications. Any and all such modifications as would be obvious to those skilled in the art are intended to be covered within the scope of the following claims.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A computer-based method of collecting and reporting adverse events associated with a patient comprising:
providing a user interface capable of (i) prompting a user to identify information to be associated with a patient, said information including at least one of personal information, medical information, drug information, adverse event information, and (ii) associating said drug information and said medical information with said adverse event information in response to a request from said user; and
displaying iteratively a cumulative narrative on said user interface in response to said user identifying at least one of said personal information, medical information, drug information, adverse event information, and said association, said cumulative narrative describing said information in a standard format using a standardized nomenclature.

2. The method of claim 1, wherein said user is selected from at least one of a medical professional, a pharmacist and said patient.

3. The method of claim 1, further comprising transmitting said cumulative narrative to a regulatory body.

4. The method of claim 1, further comprising transmitting said cumulative narrative to a manufacturer or data collection organization.

5. The method of claim 1, wherein prompting said user to identify said information to be associated with said patient comprises guiding said user using a plurality of display panels included in said user interface.

6. The method of claim 1, wherein prompting said user to identify said information to be associated with said patient comprises providing a user-selectable list on said user interface, said user-selectable list including entries conforming to said standardized nomenclature.

7. The method of claim 1, wherein prompting said user for said personal information comprises providing a data entry area on said user interface for specifying a patient's initials, a patient-gender identifier, and a patient date-of-birth.

8. The method of claim 1, wherein prompting said user for said medical information comprises providing a user-selectable list including entries of a case outcome on said user interface, said entries selected from the group consisting of ‘congenital anomaly/birth defect’, ‘death’, ‘disabilities or permanent damage’, ‘hospitalization (initial or prolonged)’, ‘life-threatening’, ‘other serious/important medical event’ and combinations thereof.

9. The method of claim 1, wherein prompting said user for said medical information comprises providing a user-selectable list including entries of a current relevant medical condition on said user interface, said entries defined by said standardized nomenclature.

10. The method of claim 1, wherein prompting said user for said medical information comprises providing a user-selectable list including entries of a relevant surgery procedure name on said user interface, said entries defined by said standardized nomenclature.

11. The method of claim 1, wherein prompting said user for said drug information comprises providing a data selection area on said user interface for specifying a drug name, suspect identifier, start date and end date.

12. The method of claim 1, wherein prompting said user for said adverse event information comprises providing a data selection area on said user interface for identifying a drug name, a severity identifier, a start date and an end date.

13. The method of claim 1, wherein describing said information using said standardized nomenclature comprises selecting and displaying a drug term from a WHO Drug Dictionary.

14. The method of claim 1, wherein describing said information using said standardized nomenclature comprises selecting and displaying a medical term from a Medical Dictionary for Regulatory Activities (MedDRA) database.

15. The method of claim 1, wherein describing said information in said standard format comprises formatting said cumulative narrative into an E2B data format.

16. The method of claim 15, further comprising transmitting said E2B data format to at least one of a regulatory database and company safety database.

17. The method of claim 16, comprising providing an electronic acknowledgement to said user upon transmission of said E2B data format.

18. The method of claim 1, further comprising storing said cumulative narrative in a database.

19. The method of claim 1, wherein providing said user interface comprises transmitting said user interface over a network to a display device.

20. The method of claim 1, wherein associating said drug information and said medical information with said adverse event information comprises dragging at least one of said drug information and said medical information onto said adverse event information displayed on said user interface

21. A system for collecting and reporting adverse events associated with a patient comprising:
a network;
a user device coupled to said network, said user device configured to include a display;
a service delivery device coupled to the network, the service delivery device including a processor and memory storing instructions that, in response to receiving a first type of request for access to a service, cause the processor to:
provide a user interface on said display capable of (i) prompting a user to identify information to be associated with a patient, said information including at least one of personal information, medical information, drug information, adverse event information, and (ii) associating said drug information and said medical information with said adverse event information; and
display iteratively a cumulative narrative on said user interface in response to said user identifying at least one of said personal information, medical information, drug information, adverse event information, and said association, said cumulative narrative describing said information in a standard format using a standardized nomenclature.

22. The system of claim 21, wherein said user is selected from the group consisting essentially of a medical professional, pharmacist and said patient.

23. The system of claim 21 wherein the memory stores instructions that, in response to receiving said first type of request over said network, cause the processor to transmit said cumulative narrative to a regulatory body.

24. The system of claim 21 wherein the memory stores instructions that, in response to receiving said first type of request over said network, cause the processor to transmit said cumulative narrative to a manufacturer.

25. The system of claim 21 wherein the memory stores instructions that, in response to receiving said first type of request over said network, cause the processor to guide said user in specifying at least one of personal information, medical information, drug information, adverse event information using a plurality of display panels included in said user interface.

26. The system of claim 21 wherein the memory stores instructions that, in response to receiving said first type of request over said network, cause the processor to provide a user-selectable list on said user interface, said user-selectable list including entries conforming to said standardized nomenclature.

27. The system of claim 21 wherein the memory stores instructions that, in response to receiving said first type of request over said network, cause the processor to provide a data entry area on said user interface for specifying a patient's initials, a patient-gender identifier, and a patient date-of-birth.

28. The system of claim 21 wherein the memory stores instructions that, in response to receiving said first type of request over said network, cause the processor to provide a user-selectable list including entries of a case outcome on said user interface, said entries selected from the group consisting of ‘congenital anomaly/birth defect’, ‘death’, ‘disabilities or permanent damage’, ‘hospitalization (initial or prolonged)’, ‘life-threatening’, ‘other serious/important medical event’ and combinations thereof.

29. The system of claim 21 wherein the memory stores instructions that, in response to receiving said first type of request over said network, cause the processor to provide a user-selectable list including entries of a current relevant medical condition on said user interface, said entries defined by said standardized nomenclature.

30. The system of claim 21 wherein the memory stores instructions that, in response to receiving said first type of request over said network, cause the processor to provide a user-selectable list including entries of a relevant surgery procedure name on said user interface, said entries defined by said standardized nomenclature.

31. The system of claim 21 wherein the memory stores instructions that, in response to receiving said first type of request over said network, cause the processor to provide a data selection area on said user interface for specifying a drug name, suspect identifier, start date and end date.

32. The system of claim 21 wherein the memory stores instructions that, in response to receiving said first type of request over said network, cause the processor to provide a data selection area on said user interface for identifying a drug name, a severity identifier, a start date and an end date.

33. The system of claim 21 wherein the memory stores instructions that, in response to receiving said first type of request over said network, cause the processor to select and display a drug term from a WHO Drug Dictionary.

34. The system of claim 21 wherein the memory stores instructions that, in response to receiving said first type of request over said network, cause the processor to select and display a medical term from a Medical Dictionary for Regulatory Activities (MedDRA) database.

35. The system of claim 21 wherein the memory stores instructions that, in response to receiving said first type of request over said network, cause the processor to associate said drug information and said medical information with said adverse event information in response to said user dragging at least one of said drug information and said medical information onto said adverse event information.

36. The system of claim 21 wherein the memory stores instructions that, in response to receiving a second type of request over said network, cause the processor to format said cumulative narrative into an E2B data format.

37. The system of claim 36 wherein the memory stores instructions that, in response to receiving the second type of request over said network, cause the processor to transmit said E2B data format to at least one of a regulatory database and company safety database over said network.

38. The system of claim 36 wherein the memory stores instructions that, in response to receiving the second type of request over said network, cause the processor to provide an electronic acknowledgement to said user upon transmission of said E2B data format.

39. The system of claim 36 wherein the memory stores instructions that, in response to receiving the second type of request over said network, cause the processor to store said cumulative narrative in a database.

40. The system of claim 21, wherein said network is an Internet-based network.

41. An article comprising a machine-readable medium storing machine-readable instructions that, when applied to a machine, cause the machine to:
provide a user interface on said display capable of (i) prompting a user to identify information to be associated with a patient, said information including at least one of personal information, medical information, drug information, adverse event information, and (ii) associating said drug information and said medical information with said adverse event information in response to a first type of request from said user; and
display iteratively a cumulative narrative on said user interface in response to said user identifying at least one of said personal information, medical information, drug information, adverse event information, and said association, said cumulative narrative describing said information in a standard format using a standardized nomenclature.

42. The article of claim 41 including instructions that, when applied to the machine, cause the machine to transmit said cumulative narrative to a regulatory body.

43. The article of claim 41 including instructions that, when applied to the machine, cause the machine to transmit said cumulative narrative to a manufacturer.

44. The article of claim 41 including instructions that, when applied to the machine, cause the machine to guide said user in specifying at least one of personal information, medical information, drug information, adverse event information using a plurality of display panels included in said user interface.

45. The article of claim 41 including instructions that, when applied to the machine, cause the machine to provide a user-selectable list on said user interface, said user-selectable list including entries conforming to said standardized nomenclature.

46. The article of claim 41 including instructions that, when applied to the machine, cause the machine to provide a data entry area on said user interface for specifying a patient initial, a patient-gender identifier, and a patient date-of-birth.

47. The article of claim 41 including instructions that, when applied to the machine, cause the machine to provide a user-selectable list including entries of a case outcome on said user interface, said entries selected from the group consisting of ‘congenital anomaly/birth defect’, ‘death’, ‘disabilities or permanent damage’, ‘hospitalization (initial or prolonged)’, ‘life-threatening’, ‘other serious/important medical event’ and combinations thereof.

48. The article of claim 41 including instructions that, when applied to the machine, cause the machine to provide a user-selectable list including entries of a current relevant medical condition on said user interface, said entries defined by said standardized nomenclature.

49. The article of claim 41 including instructions that, when applied to the machine, cause the machine to provide a user-selectable list including entries of a relevant surgery procedure name on said user interface, said entries defined by said standardized nomenclature.

50. The article of claim 41 including instructions that, when applied to the machine, cause the machine to provide a data selection area on said user interface for specifying a drug name, suspect identifier, start date and end date.

51. The article of claim 41 including instructions that, when applied to the machine, cause the machine to provide a data selection area on said user interface for identifying a drug name, a severity identifier, a start date and an end date.

52. The article of claim 41 including instructions that, when applied to the machine, cause the machine to select and display a drug term from a WHO Drug Dictionary.

53. The article of claim 41 including instructions that, when applied to the machine, cause the machine to select and display a medical term from a Medical Dictionary for Regulatory Activities (MedDRA) database.

54. The article of claim 41 including instructions that, when applied to the machine, cause the machine to format said cumulative narrative into an E2B data format.

55. The article of claim 54 including instructions that, when applied to the machine, cause the machine to transmit said E2B data format to at least one of a regulatory database and company safety database over said network.

56. The article of claim 55 including instructions that, when applied to the machine, cause the machine to provide an electronic acknowledgement to said user upon transmission of said E2B data format.

57. The article of claim 54 including instructions that, when applied to the machine, cause the machine to store said cumulative narrative in a database.

58. The article of claim 41 including instructions that, when applied to the machine, cause the machine to associate said drug information and said medical information with said adverse event information in response to said user dragging at least one of said drug information and said medical information onto said adverse event information.
